(19) United States
(12) Patent Application Publication
(10) Pub. No.: US 2024/0191695 A1
(43) Pub. Date: Jun. 13, 2024

(54) OFFSHORE WIND TURBINE WITH A FLOATING PLATFORM

(71) Applicant: STIESDAL OFFSHORE A/S, Give (DK)

(72) Inventor: Henrik Stiesdal, Odense (DK)

(21) Appl. No.: 18/286,239

(22) PCT Filed: Apr. 7, 2022
(86) PCT No.: PCT/DK2022/050073

§ 371 Date: Oct. 10, 2023

(30) Foreign Application Priority Data
Apr. 12, 2021 (DK) PA 2021 70169

(51) Int. Cl. F03D 13/25; B63B 35/44; B63B 43/06

(52) U.S. Cl. CPC F03D 13/256; B63B 35/44; B63B 43/06; B63B 2035/446

(57) ABSTRACT

An offshore wind turbine system is provided including a wind turbine in combination with a floating platform. The platform includes three buoyancy modules in corners of a triangular configuration. The tower is located off-centered near a baseline of the triangle midway between two buoyancy modules that are located at the ends of the baseline.

### CROSS-REFERENCE TO RELATED APPLICATIONS

This application claims priority to PCT Application No. PCT/DK2022/050073, having a filing date of Apr. 7, 2022, which is based on DK Application No. PA 2021 70169, having a filing date of Apr. 12, 2021, the entire contents both of which are hereby incorporated by reference.

### FIELD OF TECHNOLOGY

The following relates to a floating platform for a wind turbine. In particular, it relates to a wind turbine and floating structure.

### BACKGROUND

For floating platforms for offshore wind turbines, triangular shapes are often desired due to their high degree of stiffness relatively to size and, thus, also with respect of the necessary material, which is substantial for large wind turbines. Examples are given in international patent application WO2017/157399.

In triangular floating platforms, each corner of the triangle typically comprises one or more vertical buoyancy columns, and the wind turbine tower is typically positioned in the center of the triangle. However, for large wind turbine towers, this arrangement implies challenges for the assembly, since the assembly crane has to reach from the periphery of the platform to the center of the platform, which can be up to 35 m or more.

In some configurations of triangular floating platforms, it has been desired to position the wind turbine above one of the corners, since it can then be easily reached by the crane. A corner position has turned out not to be optimal, however, since the added weight of the turbine on one corner needs to be compensated by similar weight added to the two other corners. Installing a 2000-ton turbine on one corner thereby leads to a need to add 1000 tons of ballast at each of the two other corners. This significant addition of balancing ballast typically leads to an undesirable draft, which will often exceed 12 m. A draft not exceeding 8 m would be desirable, since this significantly expands the number of ports available for floating offshore wind installations.

It is an aspect of embodiments of the invention to disclose a configuration of a triangular floating offshore wind platform that significantly reduces the crane reach required for turbine installation while at the same time maintaining a moderate draft.

### SUMMARY

An aspect relates to an improved configuration for floating offshore platforms.

In short, the aspect is achieved with an offshore wind turbine system comprising a wind turbine in combination with a floating platform. The platform comprises three buoyancy modules in corners of a triangular configuration. The tower is located off-centered near a baseline of the triangle midway or almost midway between two buoyancy modules that are located at the ends of the baseline.

The term “buoyancy module” is used for an element that provides buoyancy and/or stability to the platform. For example, the buoyancy module is a buoyancy tank or comprises a plurality of buoyancy tanks fitted together. In some embodiments, a buoyancy module comprises or is a vertical or near-vertical cylinder, a group of two or more vertical or near-vertical cylinders, or other configuration of relevant vertical or near-vertical vessels that are located at the corners of the triangular configuration and can provide buoyancy and/or stability to the platform.

As compared to the conventional art, where the tower is supported in the center of a triangular configuration, the presented construction significantly reduces the outreach of the crane used to install the wind turbine on the platform.

As compared to the conventional art, where the tower is supported in a corner of a triangular configuration, the presented construction requires less ballasting to counterbalance the weight of the load of the wind turbine, as not one but two buoyancy modules are used to support the turbine. This reduces the operational depth when the turbine is installed. For example, installing an offshore wind turbine with a power rating of 15 MW would typically require a water depth in the order of 12 m for a corner location of the wind turbine, whereas this presented construction only requires a depth in the order of 8 m, seeing that two corner buoyancy modules, one at each end of the baseline, support the tower.

It is pointed out that this typically implies that the third buoyancy module is provided with some ballast to balance the platform, for example a ballast on the order of one-third to two-thirds of the weight of the wind turbine.

In more detail, the offshore platform comprises a tower support, for example tower support column, which carries the tower of the wind turbine, the tower carrying a wind rotor. The platform comprises three buoyancy modules. For example, each module comprises a group of buoyancy members, for example a group of two, three or more buoyancy members, such as buoyancy tanks. The buoyancy modules are lighter than water and provide buoyancy to the platform when in water. The three modules are arranged in a triangular configuration in corners of an isosceles triangle, which has a base line and two equally long sides extending from two base corners at ends of the baseline and meeting at a top corner of the triangle. In some embodiments, the isosceles triangle is an equilateral triangle with three equally long sides.

In some embodiments, the center axis of the tower is located equidistant to the base corners and located on the baseline. Alternatively, it is located at a distance to the baseline, inside or outside of the triangle. In an embodiment, the distance is in the range of 0-15% of the length L of the baseline, for example 0-15% of the length L of the baseline.

For example, the tower is located on a line that extends from the top corner through the middle of the base line.

Although the typical position of the center axis of the tower is in the middle of the base line, a slight deviation from the equidistance to the baseline corners is also possible. For example, the deviation is within 2% to 10%, such as with 2% to 5%.

A 10% deviation from an equidistant configuration would imply that the distance to one baseline corner is 0.55 L and to the other baseline corner is 0.45 L, each distance from the centerline of the tower to the baseline corners being reduced or enlarged by 10% of L/2.

But typically, the deviation is less and rather in the range of 2% to 5%. A minor asymmetry can be advantageous in that it may reduce eigenfrequency issues whilst maintaining the required load and support capability.

In some practical embodiments, the platform comprises a frame of rigid tubular members, in particular braces, that are connecting the buoyancy modules with the tower support. A convenient and useful configuration is a tetrahedral or approximately tetrahedral configuration.

For example, the frame comprises an arrangement of braces where each buoyancy member is connected to the tower support with a support brace connecting the buoyancy member to the base of the tower support and with an additional brace that are connecting the buoyancy module to the upper part, for example top, of the tower support. In an embodiment, the buoyancy modules may be connected to each other with supplementary braces. This arrangement of braces may in total form a tetrahedral shape.

In embodiments, the method of installation of the tower comprises an act of locating the floating platform adjacent to a quay wall with the tower support, such as tower support column, arranged separately from the buoyancy modules and arranged with the centerline of the tower in a position on or adjacent to the base line, near or at the center of the baseline, with the base line arranged adjacent to the quay wall. The tower and the nacelle and rotor are then installed on the tower support of the floating platform. Following this installation, the floating platform may be towed to the final location offshore. This arrangement allows for installing the wind turbine directly on the floating platform while the floating platform is in the port without requiring excessive crane reach even in a port with relatively low depth adjacent to the quay wall. Two buoyancy modules, for example buoyancy tanks, will support the weight of the wind turbine whilst the third buoyancy module, for example buoyancy tank, will provide counterweight and stability. The third buoyancy member is at a significant distance and will not require very substantial ballasting. The entire arrangement allows for placing even large-scale load on large scale floating platforms in ports with otherwise imposed limits caused by the depth.

As an example, a 15 MW wind turbine may be installed on a floating platform as disclosed docked at a quay in a port with a depth of no more than 8 m. In an embodiment, the draft during installation, i.e., whilst floating, of any buoyancy member may be less than 8 m. The draft, also during installation, of the third buoyancy member may be less than 8 m, less than 6 m, or less than 4 m.

### BRIEF DESCRIPTION

Some of the embodiments will be described in detail, with references to the following Figures, wherein like designations denote like members, wherein:

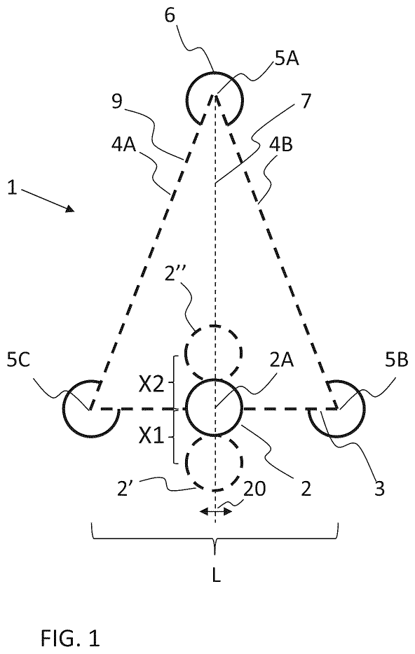

FIG. 1 illustrates a triangular construction principle for a floating platform for a wind turbine;

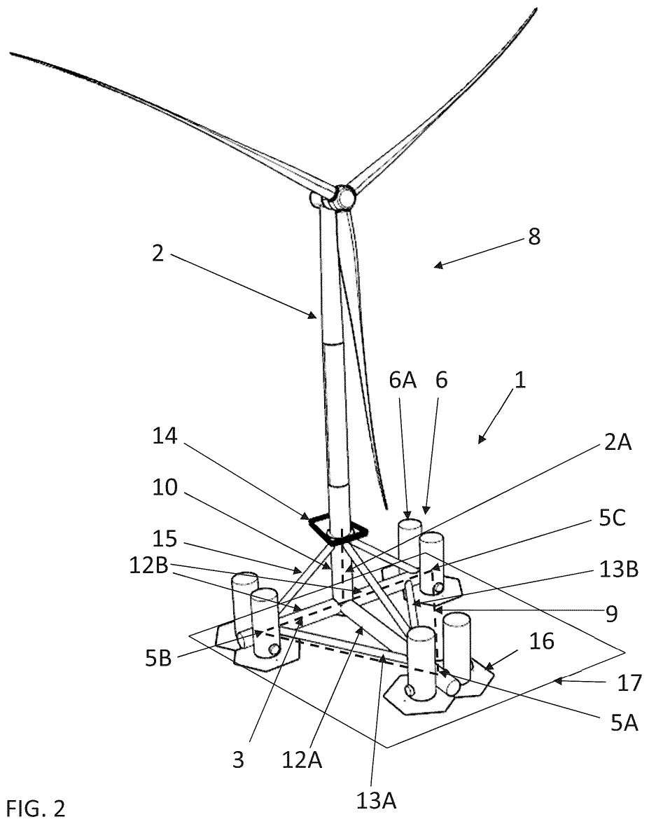

FIG. 2 illustrates a wind turbine on a floating platform;

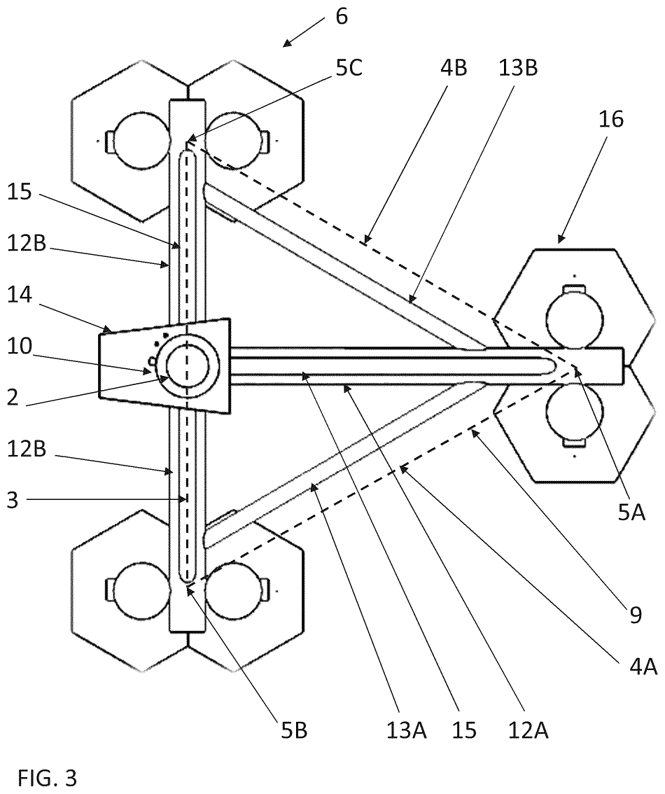

FIG. 3 illustrates a top view of the floating platform of FIG. 2;

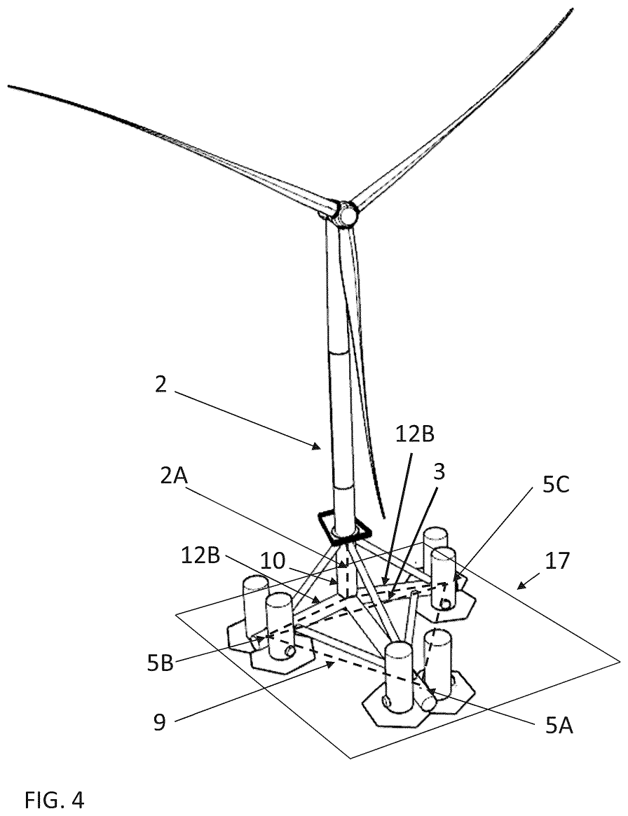

FIG. 4 illustrates an alternative embodiment;

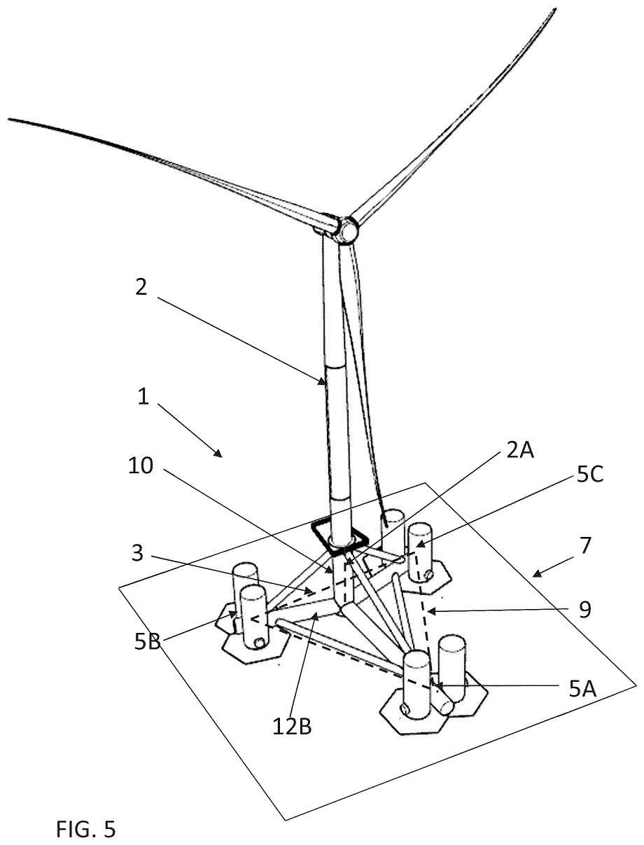

FIG. 5 illustrates a further alternative embodiment;

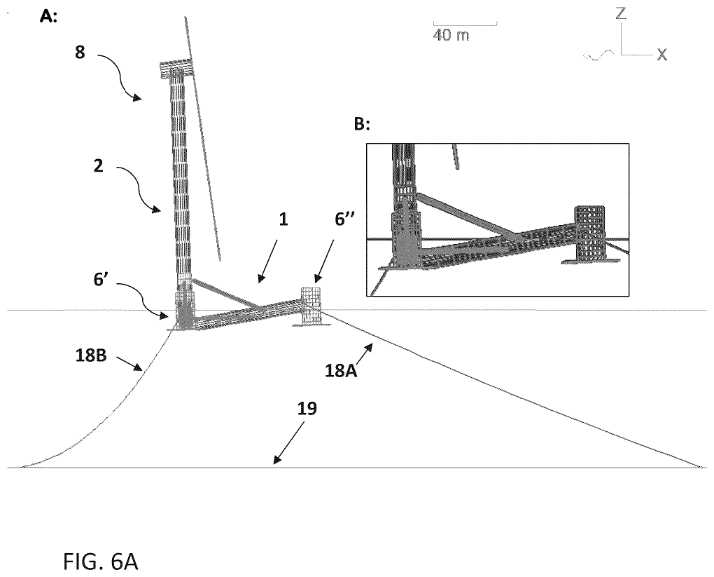

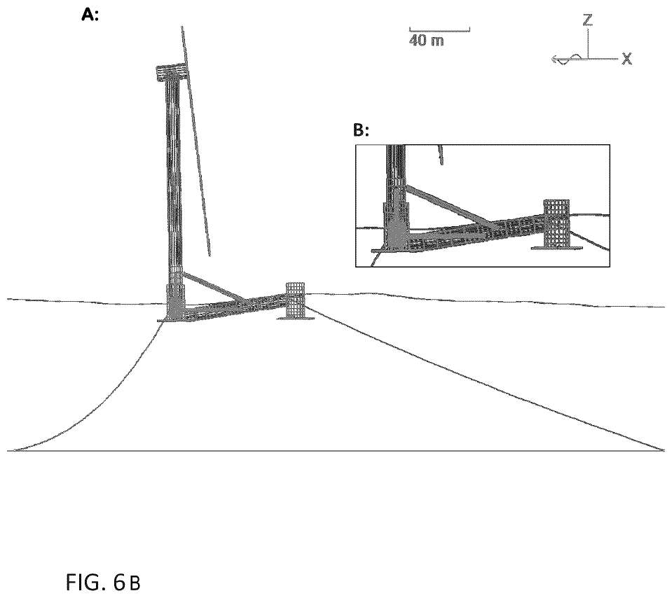

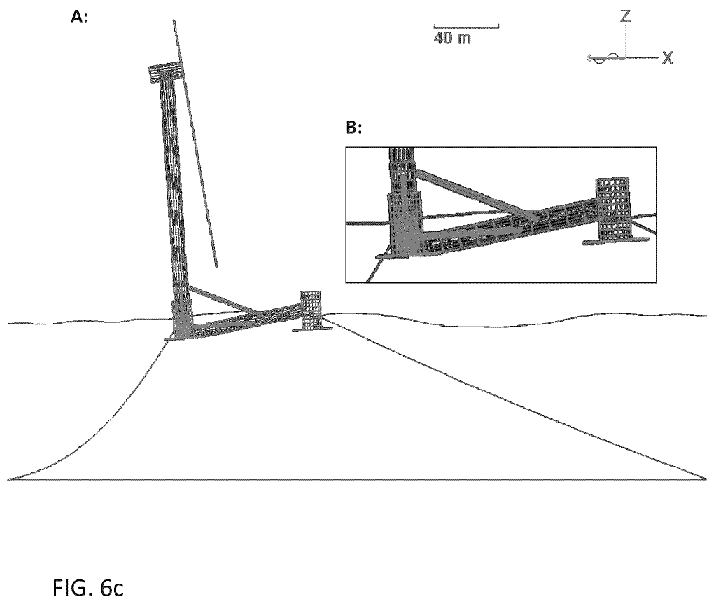

FIG. 6A illustrates the floating platform in use in deep sea, when exposed to calm water surface;

FIG. 6B illustrates the floating platform in use in deep sea, when exposed to low waves; and

FIG. 6C illustrates the floating platform in use in deep sea, when exposed to high waves.

### DETAILED DESCRIPTION

FIG. 1 is a sketch for explaining the principle of a triangular platform 1 and the location of the wind turbine tower 2 on the platform 1. At the corners 5A, 5B, 5C, buoyancy modules 6 are provided, which are dimensioned for providing sufficient buoyancy for holding the platform 1 with the wind turbine at the surface of the water, in which the offshore platform 1 is floating.

The reference triangle 9, which is used for describing the triangular shape of the platform 1 as well as the location of the tower 2, extends from the centers of single buoyancy modules 6.

However, in typical practical cases, the buoyancy module 6 in each corner 5A, 5B, 5C is not a single member but a group of buoyancy members, for example tanks. The center of the buoyancy module 6 then has to be constructed as the center for the plurality of buoyancy members, for example the center between the two buoyancy members in a pair of buoyancy members.

In the current exemplification, the triangle 9 is an isosceles triangle with a base line 3 and two equally long sides 4A, 4B that meet at the top corner 5A. However, it could also be an equilateral triangle.

The tower 2 is located on an imaginary line 7 that extends from the top corner 5A through the middle of the base line 3. For example, the line 7 follows a tubular support brace as part of a frame of the platform 1.

Typically, the tower 2 is positioned with its center 2A located on the middle of the baseline 3. However, in some embodiments, the center of the tower 2 is outside the triangle 9 and dislocated a distance X1 from the baseline 3, which is indicated with the reference number 2′. This configuration has an advantage of coming closer to the crane that is mounting the tower 2 onto the platform, especially when the buoyancy modules cover a large diameter.

As will be shown in greater detail below, this is desired when the buoyancy modules 6 are arranged in more complex configurations than illustrated in FIG. 1. For example, X1 is in the range of 0-15% of the length L of the baseline, potentially 0-10% of the length L.

Alternatively, the tower 2 is optionally located inside the triangle, dislocated a distance X2 from the baseline 3 towards the center of the triangle 9. This is indicated by the reference number 2″. For example, X2 is in the range of 0-15% of the length L of the baseline, potentially 0-10% of the length L. This is advantageous in resulting in a lower necessary depth for the platform during mounting, as the weight of the wind tower is loaded more onto the buoyancy module 6 at the top corner 5A.

Although, in most cases, the centerline 2A of the tower is located equidistant to the base corners 5B, 5C, in some cases, a slight deviation 20 from such equidistant configuration may be desired to counteract resonance frequencies. Such slight deviation 20 is typically less than 5% of L and would normally not exceed 10% of L.

FIG. 2 illustrates an example of a floating platform 1 configured to support a wind turbine 8. The platform 1 is configured with a tower support, in the form of a power support column 10, supporting the wind turbine tower 2. Three buoyancy modules 6, in the form of pairs of buoyancy members 6A, such as tanks, are providing buoyancy and stability. The buoyancy members 6A are arranged at corners 5A, 5B, 5C of the planar triangle 9. At the lower end, each of the buoyancy member 6A is provided with a heave plate 16 for damping vertical motion in the sea. The heave plates 16 are within a reference plane 17, which is parallel to the reference triangle 9 and perpendicular to the center line 2A of the cylindrical tower 2. In some embodiments, the heave plates 16 are collapsible for convenience when maneuvering in a harbor.

The platform 1 achieves stability by a tubular structure, comprising a first support brace 12A, which extends from the most distal buoyancy module 6, at the top corner 5A, to the tower support column 10, and two further support braces 12B, possibly combined into a single further support brace, that extends from the tower support column 10 to each of the other two buoyancy modules 6 at the baseline corners 5B, 5C. Further stability is achieved by additional braces 13A and 13B that extend from the two further support braces 12B to the first support brace near the buoyancy module 6 that is most distal to the tower support column 10 at the tope corner 5A. The additional braces 13A, 13B form a planar triangular shape with the two further support braces 12B. As exemplified, this planar triangle is in the same plane as the reference triangle 9.

Stabilizer braces 15 extend from an upper end of the support tower support column 10 to each of the support braces 12A, 12B at the position of the buoyancy modules 6 in order to provide a rigid structure for the platform 1. The shape approximately resembles a tetrahedron.

A working platform 14 surrounds the tower 2 and is typically fastened to the to the tower 2.

The support tower support column 10 is provided with its center line 2A on the base line 3 midway between the buoyancy members 6 and supporting the wind turbine tower 2. This is illustrated in more detail in FIG. 3, which is a top view.

Whereas FIGS. 2 and 3 illustrated the tower being located on the base line 3, FIG. 4 shows a further embodiment of the floating platform 1 corresponding to what was indicated with the reference number 2′ in FIG. 1, namely a location of the tower outside the reference triangle and offset by a certain distance, for example corresponding to not more than 15% of the length of the base line 3. The two further support braces 12B are not parallel with the base line 3 but form an angle.

In comparison, whereas the embodiment of FIGS. 2 and 3, the combination of the first support brace 12A and the further support braces 12B for a T-shape, the embodiment in FIG. 4 resembles an arrow shape.

FIG. 5 illustrates an embodiment of the floating platform 1 corresponding to what was indicated with the reference number 2″ in FIG. 1, namely a location of the tower inside the reference triangle 9 and offset by a certain distance inward towards it, for example corresponding to no more than 15% of the length of the base line 3.

FIGS. 6A, 6B, and 6C illustrate the turbine 8 on the platform 1 in three different situations with respect to waves. FIG. 6A illustrates a calm sea. Due to the weight of the wind turbine 8, which optionally is in the order of 2000 tons (2,000,000 kg) the two buoyancy modules 6′ adjacent to the tower 2, which carry the weight of the tower 2, are deeper in the water than the buoyancy module 6″ at larger distance to the tower 2. The increased inclination of the tower 2 due to increased wind, which is illustrated by the sequence of FIGS. 6A, 6B, and 6C, presses this distal buoyancy module 6″ out of the water so that the weight of the buoyancy module 6″ as well as the weight of that part of the platform, which above the surface adds to stability. The degree by which this this distal buoyancy module 6″ and a part of the platform 1 is pressed out of the water depends on the wind on the wind turbine. However, the combination of the adjacent buoyancy modules 6′ being pressed further down and the distal buoyancy module 6″ being pressed out of the water has a stabilizing effect during wave action on the platform 1 as well as wind press on the wind turbine 8. The platform is anchored to the seabed 19 by cables 18A, 18B.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. An offshore wind turbine system comprising a wind turbine in combination with a floating platform, the platform having a tower support that carries a tower of the wind turbine, the tower carrying a wind rotor; wherein the platform includes three buoyancy modules providing buoyancy to the platform when in water, the three buoyancy modules being arranged in a triangular configuration in corners of an isosceles triangle, equilateral triangle, the triangle having a base line and two equally long sides extending from two base corners at ends of the baseline and meeting at a top corner of the triangle, wherein the platform comprises a frame of braces rigidly connecting the buoyancy modules with the tower support in an approximate tetrahedral configuration, wherein
the center axis of the tower is located
on the baseline or at a distance from the baseline, the distance being in the range of 0-15% of the length L of the baseline;
equidistant to the base corners or deviating from such equidistant configuration by less than 10% of L.

2. The system according to claim 1, wherein the center axis of the tower 2 is located outside the triangle.

3. The system according to claim 1, wherein the center axis of the tower 2 is located inside the triangle.

4. The system according to claim 1, wherein the platform comprises a frame of braces rigidly connecting the buoyancy modules with the tower support,
wherein the frame comprises a planar arrangement of braces of:
a first support brace connecting the tower support with the buoyancy module at the top corners;
a further support brace to each of the buoyancy module at the base corners, connecting them rigidly to the tower support;
additional braces and extending from opposite sides of the first support brace towards the buoyancy modules at the base corners and forming a triangular configuration with the further support brace or further support braces,
wherein the frame further comprises stabilizer braces outside the plane of the planar arrangement, the stabilizer braces connecting the tower support with the three buoyancy modules.

5. The system according to claim 4, wherein the first support brace and the further support brace or further support braces connect to the base of the tower support, and the stabilizer braces to an upper part of the tower support.

6. The system according to claim 1, wherein the buoyancy modules are dimensioned for reaching downwards into water to a depth of no more than 8 m for a wind turbine having a weight of 2,000,000 kg, when the platform at the top corners is provided with a ballast having a weight that is in the range of 30-50% of the weight of the wind turbine.

7. The system according to claim 1, wherein the center axis is located at a distance from the baseline, the distance being in the range of 0-10% of the length L of the baseline, and deviating from the equidistant configuration by less than 5% of L.

8. The system according to claim 1, wherein the center axis of the tower is located equidistant to the base corners.

9. The system according to claim 1, wherein the buoyancy module comprises a plurality of buoyancy tanks.
